(19) United States
(12) Patent Application Publication
(10) Pub. No.: US 2023/0180118 A1
(43) Pub. Date: Jun. 8, 2023

(54) METHOD AND SYSTEM FOR N3IWF SELECTION IN USER EQUIPMENT FOR NETWORK CONNECTIVITY

(71) Applicant: Samsung Electronics Co., Ltd., Suwon-si, Gyeonggi-do (KR)

(72) Inventors: Varini GUPTA, Bangalore (IN); Kundan TIWARI, Bangalore (IN); Anikethan Ramakrishna Vijaya KUMAR, Bangalore (IN); Rajavelsamy RAJADURAI, Bangalore (IN); Lalith KUMAR, Bangalore (IN)

(21) Appl. No.: 17/923,766

(22) PCT Filed: May 4, 2021
(86) PCT No.: PCT/KR2021/005605

§ 371 Date: Nov. 7, 2022

(30) Foreign Application Priority Data
May 5, 2020 (IN) 202041019090
Apr. 27, 2021 (IN) 2020 41019090

(51) Int. Cl. H04W 48/18

(52) U.S. Cl. CPC H04W 48/18; H04W 92/02

(57) ABSTRACT

The present disclosure relates to a method and a system for Non-3GPP Interworking Function (N3IWF) selection in a UE for network connectivity. The method comprising receiving, by the UE associated with the system, a configuration message from an AMF in a network. Thereafter, the method comprising configuring each of a plurality of N3IWF identifiers and associated at least one S-NSSAI present in the configuration message, wherein the each of the plurality of N3IWF identifiers is an IP address or a FQDN. Subsequently, the method comprising selecting a N3IWF identifier from the plurality of N3IWF identifiers based on a user selection of a S-NSSAI associated with the N3IWF identifier for the network connectivity. The present disclosure makes user aware of the different N3IWFs available in the network, which allows user to select right N3IWF, and hence, the services the user wants to utilize while connecting via non-3 GPP network.

### TECHNICAL FIELD

The present disclosure generally relates to a fifth generation (5G) technology for cellular networks. Particularly, but not exclusively, the present disclosure relates to Non-3GPP Interworking Function (N3IWF) selection in a User Equipment (UE) for network connectivity.

### BACKGROUND ART

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

The 3rd Generation Partnership Project (3GPP) release 15 introduced the concept of “network slicing” which allows telecom service providers to deploy an exclusive network for a user (for example, Mobile Virtual Network Operator (MVNO)) or a service (for example, enhanced Mobile Broadband (eMBB), Ultra-Reliable LowLatency Communication (URLLC) and Massive IoT (MIoT)), consisting of multiple network functions designed specifically to support the specialized service. A set of such network functions is called “network slice”. These network slices are identified using Single Network Slice Selection Assistance Information (S-NSSAI) inside a 3GPP network. Users in the network are allowed to use a network slice as long as corresponding S-NSSAI is part of their subscription and stored in Unified Data Management (UDM).

The 3GPP network can be accessed via 3GPP Radio Access Network (RAN) or non-3GPP networks (for example, residential Wi-Fi or public hotspots). When a user connects to the 3GPP network via a non-3GPP network, it connects via an interworking function called evolved Packet Data Gateway (ePDG) (in Long-Term Evolution (LTE) networks) or N3IWF (in 5G networks).

Typically, a 3GPP network deploys multiple N3IWFs for load-balancing purposes. As of the 3GPP release 15, all N3IWFs are expected to provide same connectivity to the 3GPP network—that is, all N3IWFs provide connectivity to same set of network slices (S-NSSAIs). Hence, when users connect to the 3GPP network via an N3IWF, the users do not know which network slices are supported by the N3IWF. The users send a registration request, and network determines applicable/allowed network slices for the user based on user's subscription and N3IWF configuration.

However, if a network operator intends to deploy different N3IWFs each connecting to different (set of) network slices (S-NSSAIs), in such situations, a user won't be able to access the services the user wants to utilize while connecting via non-3GPP network as the user won't be aware of the different N3IWFs available in the network, and the network slices to which each N3IWF provides connectivity to.

The information disclosed in this background of the disclosure section is for enhancement of understanding of the general background of the present disclosure and should not be taken as an acknowledgement or any form of suggestion that this information forms the prior art already known to a person skilled in the art.

### DISCLOSURE OF INVENTION

### Solution to Problem

There is a need to make user aware of the different N3IWFs (i.e., N3IWF identifiers) available in a network, and corresponding network slices to which each N3IWF provides connectivity to. With the knowledge of this information, the user having subscription to multiple S-NSSAIs is able to select right N3IWF, and hence, the services the user wants to utilize while connecting via non-3GPP network.

In an embodiment, the present disclosure relates to a method for Non-3GPP Interworking Function (N3IWF) selection in a User Equipment (UE) for network connectivity. The method comprises receiving, by the UE of a system, a configuration message from an Access and Mobility Management Function (AMF) in a network. Thereafter, the method comprises configuring, by the UE, each of a plurality of N3IWF identifiers and associated at least one Single Network Slice Selection Assistance Information (S-NSSAI) present in the configuration message, wherein the each of the plurality of N3IWF identifiers is an Internet Protocol (IP) address or a Fully Qualified Domain Name (FQDN). Subsequently, the method comprises selecting, by the UE, a N3IWF identifier from the plurality of N3IWF identifiers based on a user selection of a S-NSSAI for accessing services using the network.

In an embodiment, the present disclosure relates to a system for Non-3GPP Interworking Function (N3IWF) selection in a User Equipment (UE) for network connectivity. The system comprises an Access and Mobility Management Function (AMF), and the UE comprises a processor, and a memory communicatively coupled to the processor, wherein the memory stores processor-executable instructions, which on execution, cause the processor to receive a configuration message from the AMF in a network. Thereafter, the UE of the system is configured to configure each of a plurality of N3IWF identifiers and associated at least one Single Network Slice Selection Assistance Information (S-NSSAI) present in the configuration message, wherein the each of the plurality of N3IWF identifiers is an Internet Protocol (IP) address or a Fully Qualified Domain Name (FQDN). Subsequently, the UE is configured to select a N3IWF identifier from the plurality of N3IWF identifiers based on a user selection of a S-NSSAI for accessing services using the network.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1a illustrates an exemplary environment for service based N3IWF selection in a User Equipment (UE) for network connectivity in accordance with some embodiments of the present disclosure.

FIG. 1b illustrates a call-flow diagram providing UE with N3IWF selection information while registering to a 3GPP network via a 3GPP RAN in accordance with some embodiments of the present disclosure.

FIGS. 2a and 2b illustrate flowcharts showing method for service based N3IWF selection in a UE for network connectivity in accordance with some embodiments of the present disclosure.

FIG. 3 is a block diagram of a UE, according to an embodiment of the disclosure; and

FIG. 4 is a block diagram of a network entity, according to an embodiment of the disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While describing the embodiments, technical content that is well known in the related fields and not directly related to the disclosure will not be provided. By omitting redundant descriptions, the essence of the disclosure will not be obscured and may be clearly explained.

For the same reasons, components may be exaggerated, omitted, or schematically illustrated in drawings for clarity. Also, the size of each component does not completely reflect the actual size. In the drawings, like reference numerals denote like elements.

As used herein, the term “and/or” includes any and all combinations of one or more of the associated listed items. Expressions such as “at least one of,” when preceding a list of elements, modify the entire list of elements and do not modify the individual elements of the list. Throughout the disclosure, the expression “at least one of a, b or c” indicates only a, only b, only c, both a and b, both a and c, both b and c, all of a, b, and c, or variations thereof.

Advantages and features of one or more embodiments of the disclosure and methods of accomplishing the same may be understood more readily by reference to the following detailed description of the embodiments and the accompanying drawings. In this regard, the present embodiments may have different forms and should not be construed as being limited to the descriptions set forth herein. Rather, these embodiments are provided so that this disclosure will be thorough and complete and will fully convey the concept of the present embodiments to one of ordinary skill in the art, and the disclosure will only be defined by the appended claims.

Here, it will be understood that combinations of blocks in flowcharts or process flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated consecutively may actually be executed substantially concurrently, or the blocks may sometimes be performed in a reverse order according to the corresponding function.

Here, the term “unit” in the embodiments of the disclosure means a software component or hardware component such as a field-programmable gate array (FPGA) or an application-specific integrated circuit (ASIC) and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with a smaller number of components and “units”, or may be divided into additional components and “units”. Furthermore, the components and “units” may be embodied to reproduce one or more central processing units (CPUs) in a device or security multimedia card. Also, in the embodiments, the “unit” may include at least one processor. In the disclosure, a controller may also be referred to as a processor.

A wireless communication system has evolved from providing initial voice-oriented services to, for example, a broadband wireless communication system providing a high-speed and high-quality packet data service, such as communication standards of high speed packet access (HSPA), long-term evolution (LTE) or evolved universal terrestrial radio access (E-UTRA), and LTE-Advanced (LTE-A) of 3GPP, high rate packet data (HRPD) and ultra mobile broadband (UMB) of 3GPP2, and IEEE 802.16e. A 5th generation (5G) or new radio (NR) communication standards are being developed with 5G wireless communication systems.

Hereinafter, one or more embodiments will be described with reference to accompanying drawings. Also, in the description of the disclosure, certain detailed explanations of related functions or configurations are omitted when it is deemed that they may unnecessarily obscure the essence of the disclosure. All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies, and thus, the terms used herein have to be defined based on the meaning of the terms together with the description throughout the specification. Hereinafter, a base station may be a subject performing resource assignment of a terminal, and may be at least one of a gNode B, an eNode B, a Node B, a base station (BS), a wireless access unit, a base station controller, and a node on a network. A terminal may include user equipment (UE), a mobile station (MS), a cellular phone, a smart phone, a computer, or a multimedia system capable of performing communication functions, or the like. In the disclosure, a DL is a wireless transmission path of a signal transmitted from a base station to a terminal, and a UL is a wireless transmission path of a signal transmitted from a terminal to a base station. Throughout the specification, a layer (or a layer apparatus) may also be referred to as an entity. Also, hereinbelow, one or more embodiments of the disclosure will be described as an example of an LTE or LTE-A system, but the one or more embodiments may also be applied to other communication systems having a similar technical background or channel form. For example, 5G mobile communication technology (5G, new radio, NR) developed after LTE-A may be included. In addition, the one or more embodiments may be applied to other communication systems through some modifications within the scope of the disclosure without departing from the scope of the disclosure according to a person skilled in the art.

In an LTE system as a representative example of the broadband wireless communication system, an orthogonal frequency division multiplexing (OFDM) scheme is used in a DL and a single carrier frequency division multiplexing (SC-FDMA) scheme is used in a UL. The UL refers to a wireless link through which a terminal, UE, or a MS transmits data or control signals to a BS or a gNode B, and the DL refers to a wireless link through which a BS transmits data or control signals to a terminal. In such a multiple access scheme, data or control information of each user is classified by generally assigning and operating the data or control information such that time-frequency resources for transmitting data or control information for each user do not overlap each other, that is, such that orthogonality is established.

Terms such as a physical channel and a signal in an existing LTE or LTE-A system may be used to describe methods and apparatuses suggested in the disclosure. However, the content of the disclosure is applied to a wireless communication system, instead of the LTE or LTE-A system. In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however that the specific embodiments are not intended to limit the disclosure to examples that are disclosed. On the contrary, the disclosure is to cover modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include those components or steps only, but may include other components or steps not expressly listed or inherent to such setup or device or method. In other words, one or more elements in a system or apparatus proceeded by “comprises' a” does not, without more constraints, preclude the existence of other elements or additional elements in the system or method.

In the following detailed description of the embodiments of the disclosure, reference is made to the accompanying drawings that form a part hereof, and the drawings are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

TABLE 1

| Abbreviation | Description |
|---|---|
| 5G | fifth generation |
| LTE | Long-Term Evolution |
| MVNO | Mobile Virtual Network Operator |
| eMBB | enhanced Mobile Broadband |
| URLLC | Ultra-Reliable Low-Latency Communication |
| MIoT | Massive IoT |
| UE | User Equipment |
| AMF | Access and Mobility Function |
| NSSF | Network Slice Selection Function |
| UDM | Unified Data Management |
| NRF | Network Repository Function |
| NF | Network Function |
| FQDN | Fully Qualified Domain Name |
| RAN | Radio Access Network |
| N3IWF | Non-3GPP Interworking Function |
| IP | Internet Protocol |
| S-NSSAI | Single Network Slice Selection Assistance Information |
| TAC | Tracking Area Code |
| NAS | Non-Access Stratum |
| NSI | Network Slice Instance |
| PLMN | Public Land Mobile Network |
| HPLMN | Home Public Land Mobile Network |
| VPLMN | Visited Public Land Mobile Network |
| ePDG | evolved Packet Data Gateway |

The present disclosure can be in general be applied to telecommunication technologies including 5G, and 6G.

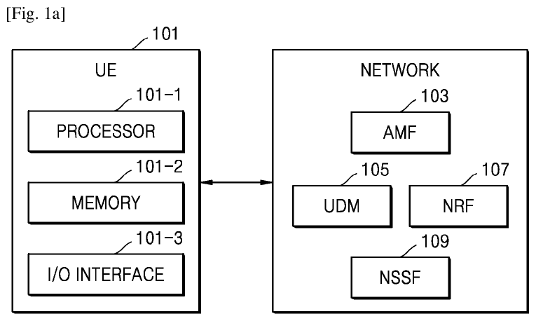

The present disclosure comprises of two parts: (1) UE-initiated registration procedure followed by (2) service-based N3IWF selection in a UE for 5G network connectivity. As shown in the FIG. 1a, the environment may include a UE 101, an AMF 103, an UDM 105, a NRF 107 and a NSSF 109. The UE 101 may be any electronic device such as, but not limited to, smartphone, capable of utilizing telecommunication technology. The UE 101 may include Central Processing Unit (“CPU” or “processor”) 101-1 and a memory 101-2 storing instructions executable by the processor 101-1. The processor 101-1 may include at least one data processor for executing program components for executing user or system-generated requests. The memory 101-2 may be communicatively coupled to the processor 101-1. The UE 101 further includes an Input/Output (I/O) interface 101-3. The I/O interface 101-3 may be coupled with the processor 101-1 through which an input signal or/and an output signal may be communicated. The 5G network of the present disclosure may comprise, but not limited to, the AMF 103, the UDM 105, the NRF 107 and/or the NSSF 109. In an embodiment, the AMF 103 may oversee registration, authentication and mobility management between the 5G network and the UE 101. The UDM 105 may manage network user data in a single, centralized element. The NRF 107 may maintain a record of available NF instances and their supported services. The NSSF 109 may select NSI based on information provided during UE attach, determine allowed NSSAI and set AMF 103 to serve the UE. For UE-initiated registration procedure, the UE 101 initiates a UE 101 registration procedure with the AMF 103 via a base station (not shown in FIG. 1a) of the 5G network. In response, the AMF 103 sends a plurality of N3IWF identifiers and associated at least one S-NSSAI for each of the plurality of N3IWF identifiers in the configuration message to the UE 101. For service based N3IWF selection in the UE 101, the UE 101 receives a configuration message from the AMF 103 in response to initiating the UE 101 registration procedure. Thereafter, the UE 101 selects a N3IWF identifier from the plurality of N3IWF identifiers based on a user selection of a S-NSSAI associated with the N3IWF identifier for the 5G network connectivity.

In one embodiment, a system of the present disclosure may comprise the UE 101 and AMF 103. In another embodiment, the system may comprise the UE 101, the AMF 103, the UDM 105, and at least one of the NRF 107 and the NSSF 109.

The operation related to the UE-initiated registration is described in detail below.

With reference to FIG. 1b, at step 111, the UE 101 initiates a UE 101 registration procedure with the AMF 103 using 3GPP RAN via a base station (not shown in FIG. 1b). The base station selects the AMF 103. The base station forwards/transmits the registration request from the UE 101 to the AMF 103. Thereafter, the AMF 103 authenticates the UE 101 and registers the UE 101 with the UDM 105 using Nudm_UECM_Registration procedure as defined in 3GPP TS 23.502. At step 113, the AMF 103 downloads UE 101's subscription information from the UDM 105 using Nudm_SDM_Get procedure. The subscription information contains user's subscribed S-NSSAIs (allowed in serving PLMN). Subsequently, one of the following steps happen:

At step 115, also shown as 3a in FIG. 1b, the AMF 103 initiates a Nssf_NSSelection procedure towards the NSSF 109 as defined in 3GPP TS 29.531 to retrieve N3IWF identifiers and associated at least one S-NSSAI from the NSSF 109. The NSSF 109 provides the AMF 103, among other information such as allowed NSSAI, a plurality of N3IWF identifiers and associated at least one S-NSSAI for each of the plurality of N3IWF identifiers to be configured in the UE 101. The plurality of N3IWF identifiers and the associated at least one S-NSSAI for each of the plurality of N3IWF identifiers is provided by the NSSF 109 based on at least one of a TAC of the UE 101, one or more S-NSSAI requested by the UE 101, and/or one or more S-NSSAI subscribed by the UE 101. Each of the plurality of N3IWF identifiers is an IP address or a FQDN.

At step 117, also shown as 3b in FIG. 1b, the AMF 103 initiates Nnrf_NFDiscovery procedure towards the NRF 107 as defined in 3GPP TS 29.510 to retrieve N3IWF identifiers and associated at least one S-NSSAI from the NRF 107. The NRF 107 provides the AMF 103 a plurality of N3IWF identifiers and associated at least one S-NSSAI for each of the plurality of N3IWF identifiers to be configured in the UE 101. The plurality of N3IWF identifiers and the associated at least one S-NSSAI for each of the plurality of N3IWF identifiers is provided by the NRF 107 based on at least one of a TAC of the UE 101, one or more S-NSSAI requested by the UE 101, and/or one or more S-NSSAI subscribed by the UE 101. Each of the plurality of N3IWF identifiers is an IP address or a FQDN.

At step 119, also shown as 3c in FIG. 1b, the AMF 103 determines/retrieves a plurality of N3IWF identifiers and associated at least one S-NSSAI for each of the plurality of N3IWF identifiers to be configured in the UE 101 using local configuration policy based on at least one of a TAC of the UE 101, one or more S-NSSAI requested by the UE 101, and/or one or more S-NSSAI subscribed by the UE 101. Each of the plurality of N3IWF identifiers is an IP address or a FQDN.

Thereafter, the AMF 103 sends the plurality of N3IWF identifiers and the associated at least one S-NSSAI for each of the plurality of N3IWF identifiers in a configuration message to the UE 101. The configuration message is one of a Registration Accept message sent in response to the initiating of UE 101 registration procedure or a UE 101 Configuration Update Command message sent after the UE 101 registration procedure or a NAS message sent after the UE 101 registration procedure. For instance, at step 121, the AMF 103 provides the plurality of N3IWF identifiers and the associated at least one S-NSSAI for each of the plurality of N3IWF identifiers to the UE 101 as part of Registration Accept message sent in response to the initiating of UE 101 registration procedure. Optionally, at step 123, the AMF 103 provides the plurality of N3IWF identifiers and the associated at least one S-NSSAI for each of the plurality of N3IWF identifiers to the UE 101 using UE 101 Configuration Update Command message as defined in 3GPP TS 23.502 after the UE 101 registration procedure. Alternatively, the AMF 103 provides the plurality of N3IWF identifiers and the associated at least one S-NSSAI for each of the plurality of N3IWF identifiers to the UE 101 using a NAS message after the UE 101 registration procedure (not shown in FIG. 1b).

The operation related to the service based N3IWF selection in the UE 101 is described in detail below.

The UE 101 receives the configuration message from the AMF 103 in response to the initiating of UE 101 registration procedure. In subsequent step, the UE 101 configures each of the plurality of N3IWF identifiers and the associated at least one S-NSSAI present in the configuration message. Each of the plurality of N3IWF identifiers is an IP address or a FQDN. The configuration message comprises a FQDN parameter to indicate whether the FQDN of the N3IWF identifier is static or dynamic. Additionally, the configuration message may comprise “Preference” parameter to indicates if an ePDG or a N3IWF is preferred in existing PLMN. Thereafter, the UE 101 selects a N3IWF identifier from the plurality of N3IWF identifiers based on a user selection of a S-NSSAI for accessing services using the 5G network. Here, services include, but not limited, MVNO, eMBB, URLLC and MIoT. When the FQDN parameter present in the configuration message indicates the FQDN of the N3IWF identifier is dynamic, then the UE 101 constructs the N3IWF identifier by adding a TAC of the UE to the FQDN. The format of the FQDN may be given as following:

tac<tac-id>.<fqdn of selected n3iwf>

The present disclosure is applicable in the following three exemplary scenarios:

Scenario 1: a user is in his/her home country but may or may not be connected to home network i.e., HPLMN. In such situation, as per the present disclosure, a plurality of N3IWF identifiers with associated at least one S-NSSAI is preconfigured in a UE, with each N3IWF identifier being an IP address or a FQDN. Thereafter, the user selects a specific N3IWF identifier depending on the services (S-NSSAIs) the user wishes to access. List of N3IWF identifiers (also, referred as a plurality of N3IWF identifiers) and associated at least one S-NSSAI to be configured is filtered/retrieved based on user's “subscribed” S-NSSAIs, which are allowed access over a non-3GPP network.

Scenario 2: a user is in his/her home network i.e., HPLMN, and operators may want to load-balance traffic across multiple N3IWF identifiers. In such situations, as per present disclosure, an AMF in the home network provides a plurality of N3IWF identifiers during mobility or a UE registration procedure based on a tracking area the UE is in. For each N3IWF identifier, the AMF of the home network, also, provides a set of supported S-NSSAIs (i.e., associated at least one S-NSSAI). The N3IWF identifier is an IP address or FQDN. The plurality of N3IWF identifiers with the associated at least one S-NSSAI is provided as part of “Registration Accept” message sent in response to the initiating of UE registration procedure or using a “UE Configuration Update” command message sent after the UE registration procedure i.e., post UE registration procedure via 3GPP RAN or using a NAS message sent after the UE registration procedure. List of N3IWF identifiers (also, referred as a plurality of N3IWF identifiers) to be configured is filtered/retrieved based on at least one of the TAC of the UE, one or more S-NSSAI requested by the UE, and one or more S-NSSAI subscribed by the UE, which are allowed access over a non-3GPP network. The list of N3IWF identifiers and associated at least one S-NSSAI are locally configured in the AMF, or is dynamically provided by a NSSF, or is dynamically discovered from an NRF, or any other existing Network Function (NF) in 3GPP architecture. The home network may, also, provide the UE with a FQDN parameter in a configuration message indicating whether a FQDN of N3IWF identifier is static or dynamic. In case the FQDN of the N3IWF identifier is dynamic, the UE constructs N3IWF identifier by adding TAC of the UE to the FQDN provided by the home network. The format of the FQDN may be given as following:

tac<tac-id>.<fqdn of selected n3iwf>

The solution described in scenario 1 may, also, be used by the UE as a fall-back mechanism, in the situation when the home network does not provide N3IWF identifier and associated S-NSSAIs when a user performs mobility, or the UE registration procedure described in scenario 2.

Scenario 3: a user is roaming and is in a visited network i.e., VPLMN, the present disclosure utilizes solution described for the scenario 2. It is possible that the UE is pre-configured, per PLMN, with a plurality of N3IWF identifiers with associated at least S-NSSAI supported in that VPLMN. The UE may utilize this information to prefer selecting a PLMN which provides required service (S-NSSAIs) over non-3GPP access. Later, the information provided by the visited network may be used to select specific N3IWF identifier according to user needs. If the user wishes to connect to HPLMN via non-3GPP access while roaming, the user can use the solution described for scenario 1.

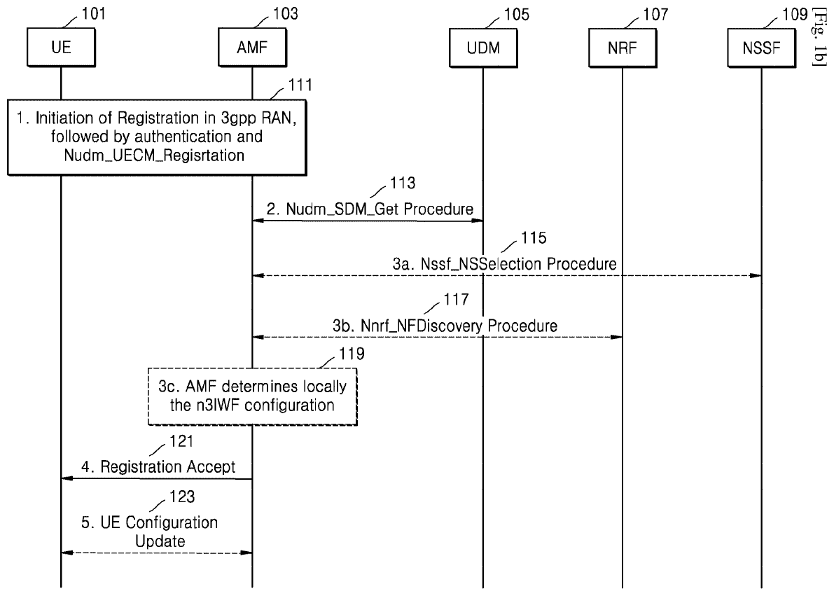

FIGS. 2a and 2b illustrate flowcharts showing method for service based N3IWF selection in a UE for network connectivity in accordance with some embodiments of the present disclosure.

As illustrated in the FIGS. 2a and 2b, the method 200 includes one or more steps for service based N3IWF selection in a UE for network connectivity. The method 200 may be described in the general context of computer executable instructions. Generally, computer executable instructions can include routines, programs, objects, components, data structures, procedures, units, and functions, which perform particular functions or implement particular abstract data types.

The order in which the method 200 is described is not intended to be construed as a limitation, and any number of the described method steps can be combined in any order to implement the method. Additionally, or alternatively, individual steps may be deleted from the methods without departing from the scope of the subject matter described herein. Furthermore, the method can be implemented in any suitable hardware, software, firmware, or combination thereof.

At step 201, the UE 101 of the system may initiate a UE registration procedure with the AMF 103.

At step 203, the AMF 103 of the system may retrieve a plurality of N3IWF identifiers and associated at least one S-NSSAI for each of the plurality of N3IWF identifiers to be configured in the UE 101 based on at least one of a TAC of the UE 101, one or more S-NSSAI requested by the UE 101, and one or more S-NSSAI subscribed by the UE 101 from one of the NSSF 109 of the network, the NRF 107 of the network and the AMF 103.

At step 205, the AMF 103 of the system may send the plurality of N3IWF identifiers and the associated at least one S-NSSAI for each of the plurality of N3IWF identifiers in the configuration message to the UE 101. The configuration message may be one of a Registration Accept message sent in response to the initiating of UE 101 registration procedure or a UE 101 Configuration Update Command message sent after the UE 101 registration procedure or a NAS message sent after the UE 101 registration procedure.

At step 207, the UE 101 of the system may receive the configuration message from the AMF 103 in the network.

At step 209, the UE 101 of the system may configure each of the plurality of N3IWF identifiers and the associated at least one S-NSSAI present in the configuration message. The each of the plurality of N3IWF identifiers may be an IP address or a FQDN. The configuration message comprising a FQDN parameter may indicate whether the FQDN of the N3IWF identifier is static or dynamic.

At step 211, the UE 101 of the system may select a N3IWF identifier from the plurality of N3IWF identifiers based on a user selection of a S-NSSAI for accessing services using the network.

At step 213, the UE 101 of the system may construct the N3IWF identifier by adding a TAC of the UE to the FQDN when a FQDN parameter present in the configuration message indicates the FQDN of the N3IWF identifier is dynamic. The format of the FQDN may be given as following:

tac<tac-id>.<fqdn of selected n3iwf>

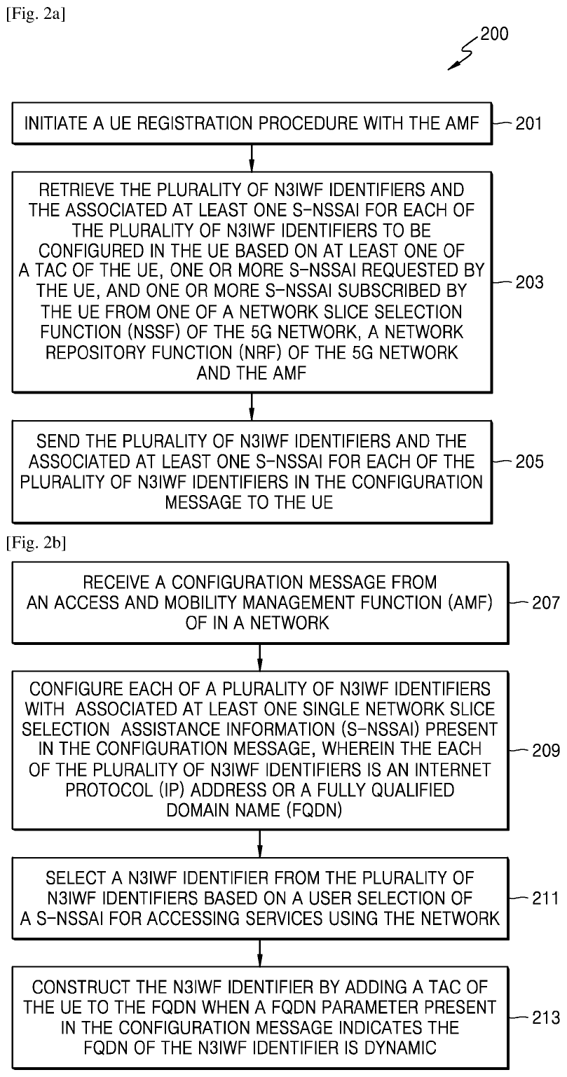

FIG. 3 is a block diagram of a UE, according to an embodiment of the disclosure.

Referring to FIG. 3, the UE may include a transceiver 302, a memory 303, and a processor 301. The transceiver 302, the memory 303, and the processor 301 of the UE may operate according to the communication method of the UE described above. However, components of the UE are not limited thereto. For example, the UE may include more or less components than those shown in FIG. 3. In addition, the transceiver 302, the memory 303, and the processor 301 may be embodied in the form of a single chip.

The transceiver 302 may transmit and receive a signal to and from a base station. Here, the signal may include control information and data. In this regard, the transceiver 302 may include a radio frequency (RF) transmitter up-converting and amplifying a frequency of a transmitted signal and an RF receiver performing low-noise amplification on a received signal and down-converting a frequency. However, such components of the transceiver 302 are only examples, and are not limited to the RF transmitter and the RF receiver.

Also, the transceiver 302 may receive a signal via a wireless channel and output the signal to the processor 301, and transmit a signal output from the processor 301 via the wireless channel.

The memory 303 may store a program and data required for an operation of the UE. Also, the memory 303 may store control information or data included in a signal obtained by the UE. The memory 303 may include a storage medium, such as read-only memory (ROM), random-access memory (RAM), a hard disk, a CD-ROM, or a DVD, or a combination thereof. Also, the memory 303 may include a plurality of memories.

The processor 301 may control a series of processes such that the UE operates according to the embodiment of the disclosure. Here, in relation to operations of the processor 301, only some of the operations of the embodiments of the disclosure have been described, but the processor 301 may control all processes such that the UE may operate according to all or some of the embodiments of the disclosure.

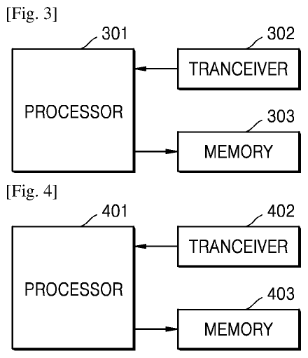

FIG. 4 is a block diagram of a network entity, according to an embodiment of the disclosure.

Referring to FIG. 4, the network entity may include a transceiver 402, a memory 403, and a processor 401. The transceiver 402, the memory 403, and the processor 401 of the network entity may operate according to the communication method of the network entity described above. However, components of the network entity are not limited thereto. For example, the network entity may include more or less components than those shown in FIG. 4. In addition, the transceiver 402, the memory 403, and the processor 401 may be embodied in the form of a single chip. According to an embodiment, the network entity may include entities included in a base station and a core network. The network entity may include the NF described above, and for example, may include an AMF, an SMF, and the like.

The transceiver 402 may transmit and receive a signal to and from a UE, a network entity, or a base station. Here, the signal may include control information and data. In this regard, the transceiver 402 may include an RF transmitter up-converting and amplifying a frequency of a transmitted signal and an RF receiver performing low-noise amplification on a received signal and down-converting a frequency. However, such components of the transceiver 402 are only examples, and are not limited to the RF transmitter and the RF receiver.

Also, the transceiver 402 may receive a signal via a wireless channel and output the signal to the processor 401, and transmit a signal output from the processor 301 via the wireless channel.

The memory 403 may store a program and data required for an operation of the network entity. Also, the memory 403 may store control information or data included in a signal obtained by the network entity. The memory 403 may include a storage medium, such as read-only memory (ROM), random-access memory (RAM), a hard disk, a CD-ROM, or a DVD, or a combination thereof. Also, the memory 403 may include a plurality of memories. According to an embodiment of the disclosure, the memory 403 may store a program for supporting beam-based cooperative communication.

The processor 401 may control a series of processes such that the network entity operates according to the embodiment of the disclosure. For example, the processor 401 may control—to perform—. The processor 401 may perform only some operations of the embodiments of the disclosure, but alternatively, may control all processes such that the network entity may operate according to all or some of the embodiments of the disclosure.

In an embodiment, the present disclosure relates to a method for Non-3GPP Interworking Function (N3IWF) selection in a User Equipment (UE) for network connectivity. The method comprises receiving, by the UE of a system, a configuration message from an Access and Mobility Management Function (AMF) in a network. Thereafter, the method comprises configuring, by the UE, each of a plurality of N3IWF identifiers and associated at least one Single Network Slice Selection Assistance Information (S-NSSAI) present in the configuration message, wherein the each of the plurality of N3IWF identifiers is an Internet Protocol (IP) address or a Fully Qualified Domain Name (FQDN). Subsequently, the method comprises selecting, by the UE, a N3IWF identifier from the plurality of N3IWF identifiers based on a user selection of a S-NSSAI for accessing services using the network.

In an embodiment, the configuration message may comprise a FQDN parameter to indicate whether the FQDN of the N3IWF identifier is static or dynamic.

In an embodiment, the method may comprise initiating, by the UE, a UE registration procedure with the AMF, retrieving, by the AMF, the plurality of N3IWF identifiers and the associated at least one S-NSSAI for each of the plurality of N3IWF identifiers to be configured in the UE based on at least one of a Tracking Area Code (TAC) of the UE, one or more S-NSSAI requested by the UE, and one or more S-NSSAI subscribed by the UE from one of a Network Slice Selection Function (NSSF) of the network, a Network Repository Function (NRF) of the network and the AMF. The method may further comprises sending, by the AMF, the plurality of N3IWF identifiers and the associated at least one S-NSSAI for each of the plurality of N3IWF identifiers in the configuration message to the UE.

In an embodiment, the configuration message is one of a Registration Accept message sent in response to the initiating of UE registration procedure or a UE Configuration Update Command message sent after the UE registration procedure or a Non-Access Stratum (NAS) message sent after the UE registration procedure.

In an embodiment, the method may further comprise constructing, by the UE, the N3IWF identifier by adding a TAC of the UE to the FQDN when a FQDN parameter present in the configuration message indicates the FQDN of the N3IWF identifier is dynamic.

In an embodiment, the present disclosure relates to a system for Non-3GPP Interworking Function (N3IWF) selection in a User Equipment (UE) for network connectivity. The system comprises an Access and Mobility Management Function (AMF), and the UE comprises a processor, and a memory communicatively coupled to the processor, wherein the memory stores processor-executable instructions, which on execution, cause the processor to receive a configuration message from the AMF in a network. Thereafter, the UE of the system is configured to configure each of a plurality of N3IWF identifiers and associated at least one Single Network Slice Selection Assistance Information (S-NSSAI) present in the configuration message, wherein the each of the plurality of N3IWF identifiers is an Internet Protocol (IP) address or a Fully Qualified Domain Name (FQDN). Subsequently, the UE is configured to select a N3IWF identifier from the plurality of N3IWF identifiers based on a user selection of a S-NSSAI for accessing services using the network.

In an embodiment, the configuration message may comprise a FQDN parameter to indicate whether the FQDN of the N3IWF identifier is static or dynamic.

In an embodiment, the system may be further configured to initiate a UE registration procedure with the AMF and retrieve the plurality of N3IWF identifiers and the associated at least one S-NSSAI for each of the plurality of N3IWF identifiers to be configured in the UE based on at least one of a Tracking Area Code (TAC) of the UE, one or more S-NSSAI requested by the UE, and one or more S-NSSAI subscribed by the UE from one of a Network Slice Selection Function (NSSF) of the network, a Network Repository Function (NRF) of the network and the AMF. The system may be further configured to send the plurality of N3IWF identifiers and the associated at least one S-NSSAI for each of the plurality of N3IWF identifiers in the configuration message to the UE.

In an embodiment, the configuration message may be one of a Registration Accept message sent in response to the initiating of UE registration procedure or a UE Configuration Update Command message sent after the UE registration procedure or a Non-Access Stratum (NAS) message sent after the UE registration procedure.

In an embodiment, the system may be further configured to construct the N3IWF identifier by adding a TAC of the UE to the FQDN when a FQDN parameter present in the configuration message indicates the FQDN of the N3IWF identifier is dynamic.

Some of the technical advantages of the present disclosure are listed below.

The present disclosure makes user aware of the different N3IWFs available in the network, and the network slices to which each N3IWF provides connectivity to. With the knowledge of this information, the user having subscription to multiple S-NSSAIs is able to select right N3IWF, and hence, the services the user wants to utilize while connecting via non-3GPP network.

The described operations may be implemented as a method, system, or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the present disclosure(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the present disclosure.

When a single device or article is described herein, it will be readily apparent that more than one device/article (whether or not the device or article cooperate) may be used in place of a single device/article. Similarly, where more than one device or article is described herein (whether or not the device or article cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as with such functionality/features. Therefore, other embodiments of the present disclosure do not include the device itself.

The illustrated operations of FIGS. 2a and 2b show certain events occurring in a certain order. In alternative embodiments, certain operations may be performed in a different order, modified or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and the language may not have been selected to delineate or circumscribe the inventive subject matter. It is therefore intended that the scope of the present disclosure be limited not by this detailed description, but rather by any claims that issue on an application based here on. Accordingly, the disclosure of the embodiments of the present disclosure is intended to be illustrative, but not limiting, of the scope of the present disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1-10. (canceled)

11. A method performed by a network entity in a wireless communication system, the method comprising:
identifying non-3GPP interworking function (N3IWF) identifier information based on one or more single network slice selection assistance informations (S-NSSAIs) subscribed at a user equipment (UE); and
transmitting, to the UE, configuration information including the N3IWF identifier information,
wherein a N3IWF that supports the S-NSSAIs subscribed at the UE is selected based on the configuration information.

12. The method of claim 11, wherein the N3IWF identifier information includes a fully qualified domain name (FQDN) associated with the N3IWF or an internet protocol (IP) address associated with the N3IWF.

13. The method of claim 11,
wherein the configuration information further includes a FQDN parameter and a preference parameter,
wherein the FQDN parameter indicates whether to construct a FQDN based on information associated with tracking area, and
wherein the preference parameter indicates whether a evolved packet data gateway (ePDG) or a N3IWF is preferred.

14. The method of claim 11, wherein the network entity is in a home public land mobile network (HPLMN).

15. A method performed by a user equipment (UE) in a wireless communication system, the method comprising:
receiving, from a network entity, configuration information including non3GPP interworking function (N3IWF) identifier information; and
selecting a N3IWF that supports one or more single network slice selection assistance informations (S-NSSAIs) subscribed at the UE based on the configuration information,
wherein the N3IWF identifier information is identified based on the S-NSSAIs subscribed at the UE.

16. The method of claim 15, wherein the N3IWF identifier information includes a fully qualified domain name (FQDN) associated with the N3IWF or an internet protocol (IP) address associated with the N3IWF.

17. The method of claim 15,
wherein the configuration information further includes a FQDN parameter and a preference parameter,
wherein the FQDN parameter indicates whether to construct a FQDN based on information associated with tracking area, and
wherein the preference parameter indicates whether a evolved packet data gateway (ePDG) or a N3IWF is preferred.

18. The method of claim 15, wherein the network entity is in a home public land mobile network (HPLMN).

19. A network entity in a wireless communication system, the network entity comprising:
a transceiver; and
at least one processor coupled with the transceiver and configured to:
identify non-3GPP interworking function (N3IWF) identifier information based on one or more single network slice selection assistance informations (S-NSSAIs) subscribed at a user equipment (UE), and
transmit, to the UE, configuration information including the N3IWF identifier information,
wherein a N3IWF that supports the S-NSSAIs subscribed at the UE is selected based on the configuration information.

20. The network entity of claim 19, wherein the N3IWF identifier information includes a fully qualified domain name (FQDN) associated with the N3IWF or an internet protocol (IP) address associated with the N3IWF.

21. The network entity of claim 19,
wherein the configuration information further includes a FQDN parameter and a preference parameter,
wherein the FQDN parameter indicates whether to construct a FQDN based on information associated with tracking area, and
wherein the preference parameter indicates whether a evolved packet data gateway (ePDG) or a N3IWF is preferred.

22. The network entity of claim 19, wherein the network entity is in a home public land mobile network (HPLMN).

23. A user equipment (UE) in a wireless communication system, the UE comprising:
a transceiver; and
at least one processor coupled with the transceiver and configured to:
receive, from a network entity, configuration information including non3GPP interworking function (N3IWF) identifier information, and
select a N3IWF that supports one or more single network slice selection assistance informations (S-NSSAIs) subscribed at the UE based on the configuration information,
wherein the N3IWF identifier information is identified based on the S-NSSAIs subscribed at the UE.

24. The UE of claim 23, wherein the N3IWF identifier information includes a fully qualified domain name (FQDN) associated with the N3IWF or an internet protocol (IP) address associated with the N3IWF.

25. The UE of claim 23,
wherein the configuration information further includes a FQDN parameter and a preference parameter,
wherein the FQDN parameter indicates whether to construct a FQDN based on information associated with tracking area, and
wherein the preference parameter indicates whether a evolved packet data gateway (ePDG) or a N3IWF is preferred.
